(19) United States
(12) Patent Application Publication
(10) Pub. No.: US 2005/0231361 A1
(43) Pub. Date: Oct. 20, 2005

(54) System and apparatus for locating misplaced or lost items and accessories

(76) Inventor: Darren Lee Godbey, Chehalis, WA (US)

Correspondence Address: THE INVENTORS NETWORK, INC., 332 ACADEMY STREET, CARNEGIE, PA, 15106, US

(21) Appl. No.: 10/824,886

(22) Filed: Apr. 16, 2004

(51) Int. Cl. G08B 1/08

(52) U.S. Cl. 340/539.32; 340/568.1

(57) ABSTRACT

A system and apparatus for locating lost or misplaced items, accessories, gadgets, and devices includes a pager unit removably attachable to a flat surface, such as a wall or refrigerator door, and a transmitter unit that is unobtrusively mounted to the item whereupon depressing a pager button activates and transmits a signal to the transmitter unit causing the activation of both a speaker/buzzer and a light emitting diode (LED) so that the item can be quickly and easily located and retrieved.

### FIELD OF THE INVENTION

The present invention pertains to electronic transmitting and locating systems and devices, and more particularly pertains to an electronic paging and locating system and apparatus.

### BACKGROUND OF THE INVENTION

An enormous range of items, accessories, gadgets, and devices are available for use by individuals in our contemporary technological society. The items range from items employed for personal and public safety, items utilized for convenience, items utilized for communication and entertainment, and ordinary household items. The items run the gamut from cell phones, pagers, handheld game boys, MP3 players, CD players, remote control devices for televisions, VCR and DVD players, wallets, purses, keys, garage door openers, and computer mouses.

With the proliferation of such consumer oriented items and accessories, of which the above are notable examples, has come an increase in personal comfort and convenience. However, the increase in personal comfort and convenience has also been attended by a marked increase in the busy, hectic nature of contemporary life. Thus, keeping track of all the items and accessories present in a household is not easy, and opportunities abound for misplacing or losing such items.

In the case of a game boy or MP3 player, the misplacement or loss is generally not vital to individual or household convenience, safety and welfare, but the misplacement or loss of other items may range from frustrating to dangerous. For example, many televisions, DVD, and VCR players only work with a specifically programmed remote control devices, and the misplacement or loss of such devices can render the DVD, VCR or television inoperable. The misplacement or loss of a garage door opener, for example, will make it impossible to park one's car in the garage. On a serious note, an emergency may occur that requires the immediate contact of safety personal, and if the car keys or cell phone have inadvertently been lost or misplaced, the necessary assistance may not be summoned with dire consequences for the individual.

Thus, the prior art discloses a number of devices for locating lost or misplaced items. For example, the Anderson et al. patent (U.S. Pat. No. 4,101,873) discloses a device for locating commonly misplaced objects and includes a transmitter, a receiver, and a power conservation technique whereby the receiver cycles for a minimum amount of time to receive signals from the transmitter.

The Lander patent (U.S. Pat. No. 4,476,469) discloses a locating system that includes a locator device attached to items and a hand held searcher device for communicating with one or more locator devices through selectively addressed, coded signals.

The Bayer patent (U.S. Pat. No. 4,507,653) discloses a sound detecting unit in which audible tones are generated for locating an object by the individual clapping, whistling or producing loud sounds.

The Staino, Jr. patent (U.S. Pat. No. 5,629,677) discloses apparatus for locating eyeglasses that includes a signaling mechanism placed in an envelope that is mounted to the eyeglass frame and a locator that can communicate with the signaling mechanism.

The Benvenuti patent (U.S. Pat. No. 6,166,652) discloses an item locating system that includes a receiving unit attachable to the item and which is actuated by signals sent from a transmitting station initiated by the individual placing a telephone call via the transmitting station.

The LeDain et al. patent (U.S. Pat. No. 6,246,322 B1) discloses a system for locating objects that distinguishes and filters non-triggering sounds such as music and speech from the triggering sound of hand clapping to locate the desired object.

### SUMMARY OF THE INVENTION

The present invention comprehends a system and apparatus for locating misplaced or lost items and accessories, and includes a paging unit that is removably mountable to flat surfaces such as walls or refrigerator doors and a transmitter unit that is mounted on the various items, accessories, gadgets and devices that the individual desires to keep track of and immediately locate when the need to use arises. The paging unit includes a button or switch that is manually actuated, and enclosed within the transmitter unit is electrical circuitry that activates a light and buzzer combination to provide the individual with objectively discernible signals for locating the item.

It is an objective of the present invention to provide a system and apparatus for locating items that is adaptable to numerous items, gadgets, and accessories found in the home, office, shop, and school

It is another objective of the present invention to provide a system and apparatus for locating items that is easy to operate and especially useful for household items.

It is yet another objective of the present invention to provide a system and apparatus for locating items that can be set up for use without the need for excessive technical expertise.

It is still another objective of the present invention to provide a system and apparatus that produces both audio and visual signals.

These and other objects, features, and advantages will become apparent to one skilled in the art upon a perusal of the following detailed description when read in conjunction with the appended drawing figures.

### BRIEF DESCRIPTION OF THE DRAWINGS

FIG. 1 is a perspective view of the system and apparatus for locating items of the present invention illustrating the attachment of the transmitting unit to a remote control device;

FIG. 2 is a front elevational view of the paging unit first shown in FIG. 1;

FIG. 3 is a front elevational view of the transmitting unit first shown in FIG. 1;

FIG. 4 is a rear elevational view of the transmitting unit first shown in FIG. 1; and

FIG. 5 is an electrical schematic of the system and apparatus for locating items first shown in FIG. 1.

### DETAILED DESCRIPTION OF THE PREFERRED EMBODIMENT

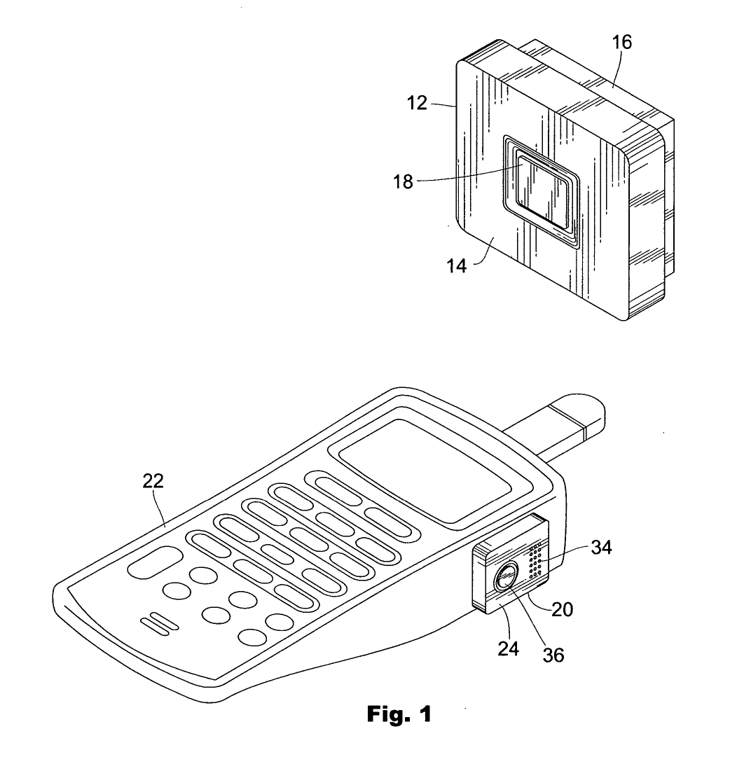

Illustrated in FIGS. 1-5 is a system and apparatus 10 for quickly and easily locating misplaced or lost items, and that is primarily, but not exclusively, intended for locating misplaced or lost household items, gadgets, and accessories such as keys, garage door openers, remote controls for the television, DVD, and VCR, purses, wallets, eyeglasses, cell phones, and more recent items like MP3 players and PDA's. The item locating system and apparatus 10 can be set up with a minimum of effort and technical expertise by individuals and ordinary homeowners and users.

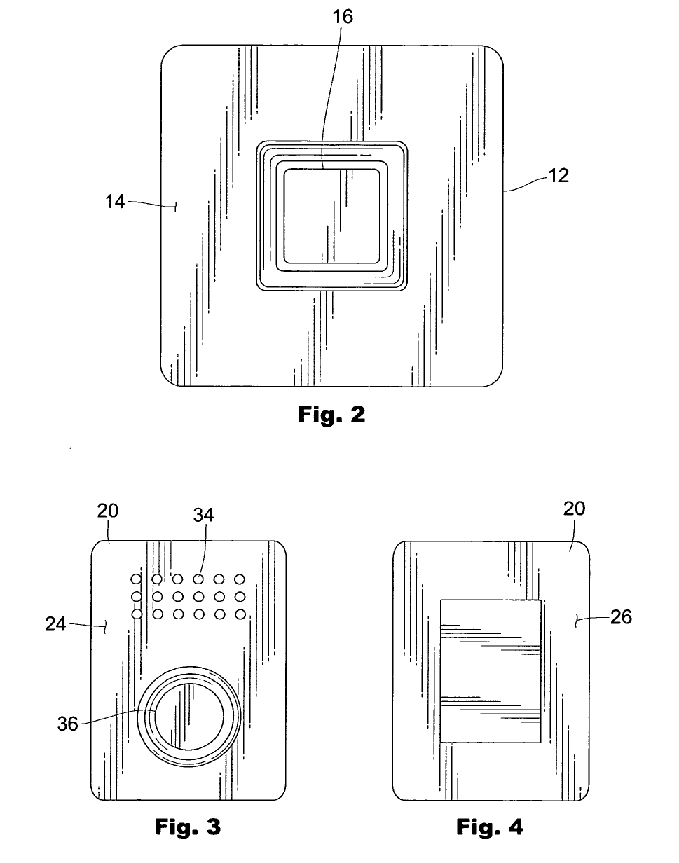

Illustrated in FIGS. 1 and 2 is a pager unit 12 that includes a front side 14 and an opposite rear mounting side 16. A manually depressible pager button 18 is located on the front side 14. The rear mounting side 16 is removably mountable to any suitable flat surface such as a dining or kitchen wall or the door of the refrigerator. The pager unit 12 should be mounted in a familiar, easy to reach place, yet should be unobtrusively mounted for aesthetic reasons. The mounting method can be any suitable method such as by using double-sided adhesive tape, screws, brackets, etc, but it is preferable that the mounting of the pager unit 12 should not be of a permanent nature.

Illustrated in FIGS. 1 and 3-5 is a transmitter unit 20 that is attached to the object to be located—such as a cell phone 22 as shown in FIG. 1—and which is activated upon the individual manually depressing the pager button 18 of the pager unit 12. The transmitter unit 20 includes a front signal emanation side 24 and an opposite rear securement side 26. The transmitter unit 20 can be secured to the object or item to be located by any suitable means such as by using double-sided adhesive tape. Generally, the means of mounting the transmitter unit 20 to the object should be such as to avoid marring the surface of the object and should not interfere with the functioning of the object, such as the cell phone 22 shown in FIG. 1.

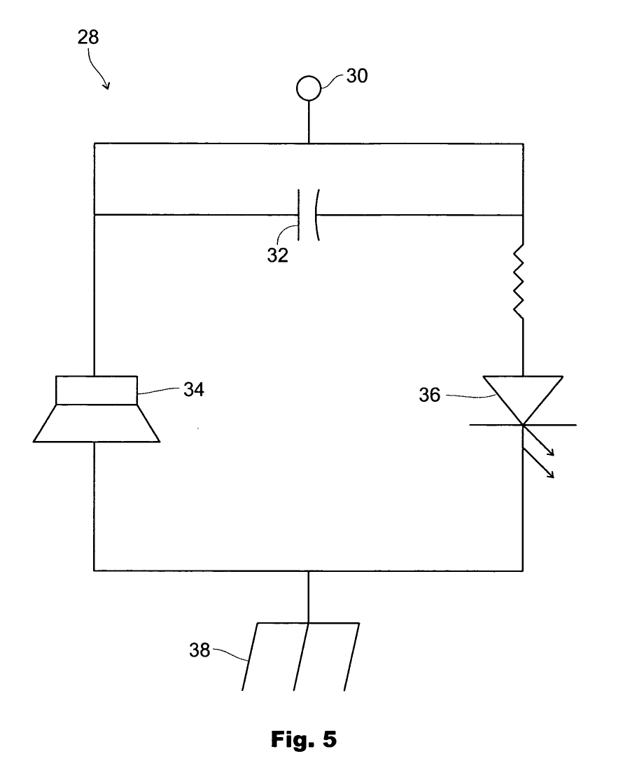

The electrical schematic 28 of FIG. 5 illustrates one embodiment for the electrical circuitry of the transmitter unit 20, and the circuitry includes a DC power source 30, a capacitor 32, a buzzer or speaker 34 and a Light emitting diode (LED) 36, with the buzzer or speaker 34 and the LED 36 electrically powered from the DC power source 30 for producing both audible and visual locating signals. The circuitry also includes a chassis ground connection 38. Manually pressing the pager button 18 causes an electrical signal of a designated frequency to be sent to the transmitter unit 20 thereby activating the buzzer or speaker 34 and the LED 36 to produce visual and audio discernible signals.

In setting up the item locating system and apparatus 10 of the present invention, the individual would first mount the pager unit 12 to a suitable flat surface, such as a kitchen wall or on the refrigerator door, notifying all the household members of the location of the pager unit 12. The transmitter unit 20 would then be mounted to the desired object, such as the cell phone 22 shown in FIG. 1. Finally, when the household members realize that the item, such as the cell phone 22 has been lost or misplaced, the pager button 18 can be manually depressed, which action will thereby actuate both the buzzer/speaker 34 and the LED 36 so that the household members can locate and retrieve the object.

The foregoing is to be considered as illustrative of the principles of the invention, and numerous modifications, alterations, and variations will occur to those skilled in the art, and it is not desired to limit the invention to the exact construction and operation shown and described, thus all suitable modifications, alterations, and variations may be resorted and still fall within the scope of the invention and the appended claims.

1. A system for locating lost or misplaced items, comprising:
a transmitter unit for attachment to the item to be located;
the transmitter unit including a buzzer and a light emitting diode that can be selectively actuated for locating the item;
the transmitter unit including a DC power source for providing power to the buzzer and the light emitting diode; and
a pager unit for mounting to a wall surface, the pager unit having a manually operable push button that upon actuation transmits a signal to the transmitter unit thereby activating the light emitting diode and the buzzer so that the item can be located.

2. A system for locating a lost or misplaced household item, comprising:
a transmitter unit for attachment to the item to be located;
the transmitter unit including a speaker and a light emitting diode that can be selectively actuated for locating the item;
the transmitter unit including a DC power source for providing power to the speaker and the light emitting diode;
a pager unit removably mountable to a flat surface, the pager unit having a manually operable push button that upon actuation transmits a signal to the transmitter unit thereby activating the light emitting diode and the speaker so that the item can be located.
